(19) United States
(12) Patent Application Publication
(10) Pub. No.: US 2012/0016863 A1
(43) Pub. Date: Jan. 19, 2012

(54) ENRICHING METADATA OF CATEGORIZED DOCUMENTS FOR SEARCH

(75) Inventors: DANIEL BERNHARDT, LONDON (GB); IAN DOUGLAS HEGERTY, ANDOVER HANTZ (GB); TOMASZ ANDRZEJ MARCINIAK, LEIMEN (DE)

(73) Assignee: MICROSOFT CORPORATION, REDMOND, WA (US)

(21) Appl. No.: 12/837,614

(22) Filed: Jul. 16, 2010

(51) Int. Cl. G06F 7/00; G06F 17/30

(52) U.S. Cl. 707/710; 707/E17.108

(57) ABSTRACT

Methods for enriching metadata associated with a document that is categorized in a document category are described. Documents are pre-categorized within a document category. Uniform resource locaters (URL) that are related to a document category are identified and linked to the document category. Indications of tokens and relationships between the tokens and the URLs are received. The tokens are linked to the URLs. The tokens are propagated to the document categories and to the documents therein based on linking between the token, URL, and document category. As such the document category, and documents therein, are provided with metadata that is descriptive thereof. The documents and their associated metadata tokens are useable to generate a searchable index of the documents. The linking between the tokens, URLs, and categories is also useable to identify tokens that are too specific, too general, or documents that are miscategorized.

### BACKGROUND

Searching for electronic documents has become commonplace in today's computing environment. Whether the documents are web- or Internet-based or contained on a single machine or network, a search engine is employed to identify desired documents based on a user-provided search query. To do so, the search engine, in general, identifies documents that contain, or are associated with, one or more terms that are included in the search query. As such, the effectiveness and precision of the search is highly dependent on the terms contained in or associated with the documents.

Further, users often have a very specific intent when generating a search query but may not be highly proficient in identifying search query terms that will result in the desired documents being found. By associating a rich collection of terms and synonyms that are descriptive of documents or categories of documents that are searched by a search engine, the demand for a well-crafted search query is reduced.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section. This summary is not intended to identify key features or essential features of the claimed subject matter, nor is it intended to be used as an aid in isolation to determine the scope of the claimed subject matter.

Embodiments of the invention include methods for enriching metadata associated with a document category or a document that is pre-categorized in one or more document categories. Document identifiers, such as uniform resource locators (URL), are associated with each document category. Tokens, such as textual words or phrases that are associated with the URLs are identified. The tokens are propagated to document categories and to document in the document category based on the URL that is linked to both token and to the document category. The tokens and documents may be indexed in a search index to inform searching of the documents and categories.

### DESCRIPTION OF THE DRAWINGS

Illustrative embodiments of the invention are described in detail below with reference to the attached drawing figures, and wherein:

FIG. 1 is a block diagram depicting an exemplary operating environment suitable for use in accordance with an embodiment of the invention;

FIG. 2 is a block diagram depicting a category that includes a plurality of documents in a flat category space in accordance with an embodiment of the invention;

FIG. 3 is a block diagram depicting a category that includes a hierarchal document arrangement;

FIG. 4 is a graphical representation of a search query entry field with a plurality of search terms in accordance with an embodiment of the invention;

FIG. 5 is a block diagram depicting a graph that represents associations between tokens, URLs, and categories in accordance with an embodiment of the invention;

FIG. 6 is a flow diagram depicting a method of enriching metadata associated with a category of documents in accordance with an embodiment of the invention;

FIG. 7A is a graphical representation depicting a search index prior to enrichment of metadata associated with a document in accordance with an embodiment of the invention;

FIG. 7B is a graphical representation depicting a search index in which document metadata has been enriched in accordance with an embodiment of the invention;

FIG. 8 is a flow diagram depicting a method for enriching metadata associated with a document that is categorized in a document category in accordance with an embodiment of the invention;

FIG. 8A is a flow diagram depicting additional steps of the method depicted in FIG. 8 in accordance with an embodiment of the invention;

FIG. 9 is a flow diagram depicting another method for enriching metadata associated with a document that is categorized in at least one of a plurality of document categories in accordance with an embodiment of the invention;

FIG. 9A is a flow diagram depicting additional steps to the method depicted in FIG. 9 in accordance with an embodiment of the invention;

FIG. 10 is a block diagram depicting a graph that represents associations between tokens, URLs, and categories and that includes a token that is too specific in accordance with an embodiment of the invention;

FIG. 11 is a block diagram depicting a graph that represents associations between tokens, URLs, and categories and that includes a token that is too general in accordance with an embodiment of the invention;

FIG. 12 is a block diagram depicting a graph that represents associations between tokens, URLs, and categories and that includes tokens and URLs that exhibit subcategories within a category in accordance with an embodiment of the invention; and

FIG. 13 is a block diagram depicting a graph that represents a mapping of categories from two taxonomies onto one another in accordance with an embodiment of the invention.

### DETAILED DESCRIPTION

The subject matter of embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Embodiments of the invention include computer-readable media and methods for enriching metadata associated with a document that is categorized in at least one of a plurality of categories. In an embodiment of the invention, computer-readable media having computer-executable instructions embodied thereon that, when executed, perform a method of enriching metadata associated with a category of documents is described. A document identifier is linked with a category of documents. Evidence of an association between a token and the document identifier is received. A token comprises data elements that are descriptive of content identified by the document identifier. The token is propagated to the category of documents that is linked with the document identifier. The token is usable as metadata for the category of documents and a document contained therein.

In another embodiment of the invention, a method performed by a computing device having a processor and memory for enriching metadata associated with a document that is categorized in a document category is described. Documents are categorized in a document category. A document identifier that is related to the document is identified. The document identifier is linked to the document category. An indication of a token and a relationship between the token and the document identifier is received. The token is linked to the document identifier. The token is automatically propagated to each of the documents that are categorized in the document category. A searchable index is generated for the documents and includes the token as metadata for each of the documents in the document category.

In another embodiment, one or more computer-readable media having computer-executable instructions embodied thereon that, when executed, perform a method of enriching metadata associated with a document that is categorized in at least one of a plurality of document categories is described. A graph that represents statistical associations between a token and a document category is generated. The graph includes document categories that each contain one or more pre-categorized documents, URLs that are associated with one or more of the document categories, and text tokens that are associated with one or more of the URLs. A text token is propagated to the documents in a document category based on the URL that is associated with both the text token and with the document category. The text token is usable as metadata that is descriptive of each of the documents in the document category.

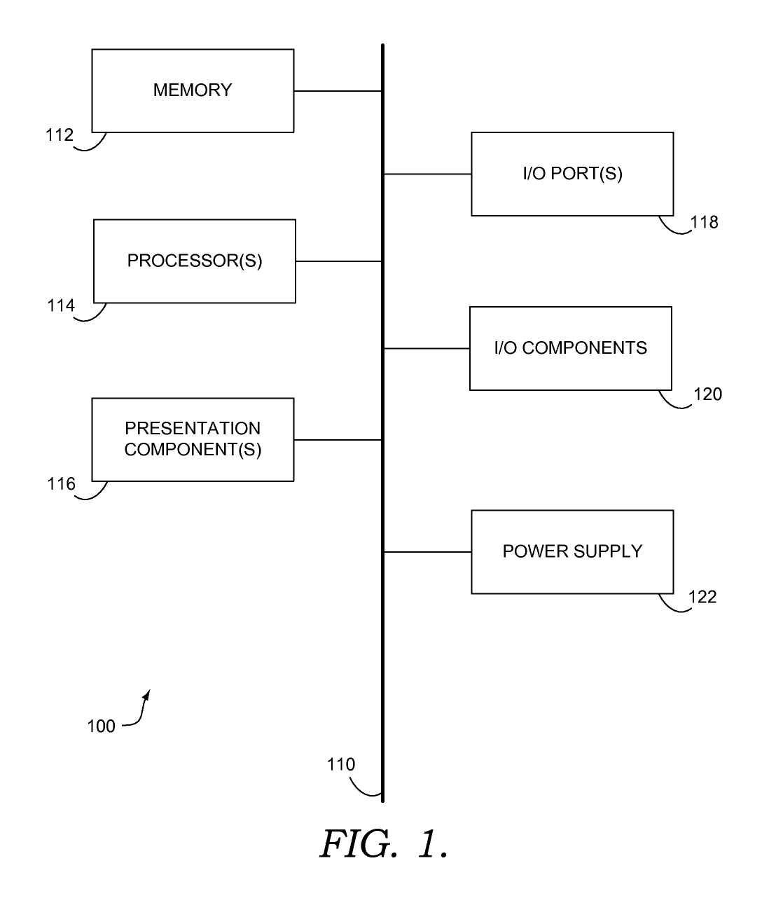

Referring initially to FIG. 1 in particular, an exemplary operating environment for implementing embodiments of the invention is shown and designated generally as a computing device 100. The computing device 100 is but one example of a suitable computing device and is not intended to suggest any limitation as to the scope of use or functionality of invention embodiments. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, the computing device 100 includes a bus 110 that directly or indirectly couples the following devices: a memory 112, one or more processors 114, one or more presentation components 116, one or more input/output ports 118, one or more input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It is recognized that such is the nature of the art, and it is reiterated that the diagram of FIG. 1 is merely illustrative of an exemplary computing device 100 that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media that is non-transitory in nature. By way of example, and not limitation, computer-readable media may comprises Random Access Memory (RAM); Read-Only Memory (ROM); Electronically Erasable Programmable Read-Only Memory (EEPROM); flash memory or other memory technologies; compact disc read-only memory (CDROM), digital versatile disks (DVD) or other optical or holographic media; magnetic cassettes, magnetic tape, magnetic disk storage or other magnetic storage devices, or any other medium that can be used to encode desired information and be accessed by computing device 100.

The memory 112 includes computer-storage media in the form of volatile and/or nonvolatile memory. The memory 112 may be removable, nonremovable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

As described herein documents include any collection of related information known in the art such as, for example, and not limitation, text-based documents, web pages, spreadsheets, images, videos, audio files, or any combination thereof. The documents may have one or more tags, descriptors, or other metadata associated therewith. The metadata is manually associated with the document by a user, automatically by one or more applications, or by any other methods known in the art.

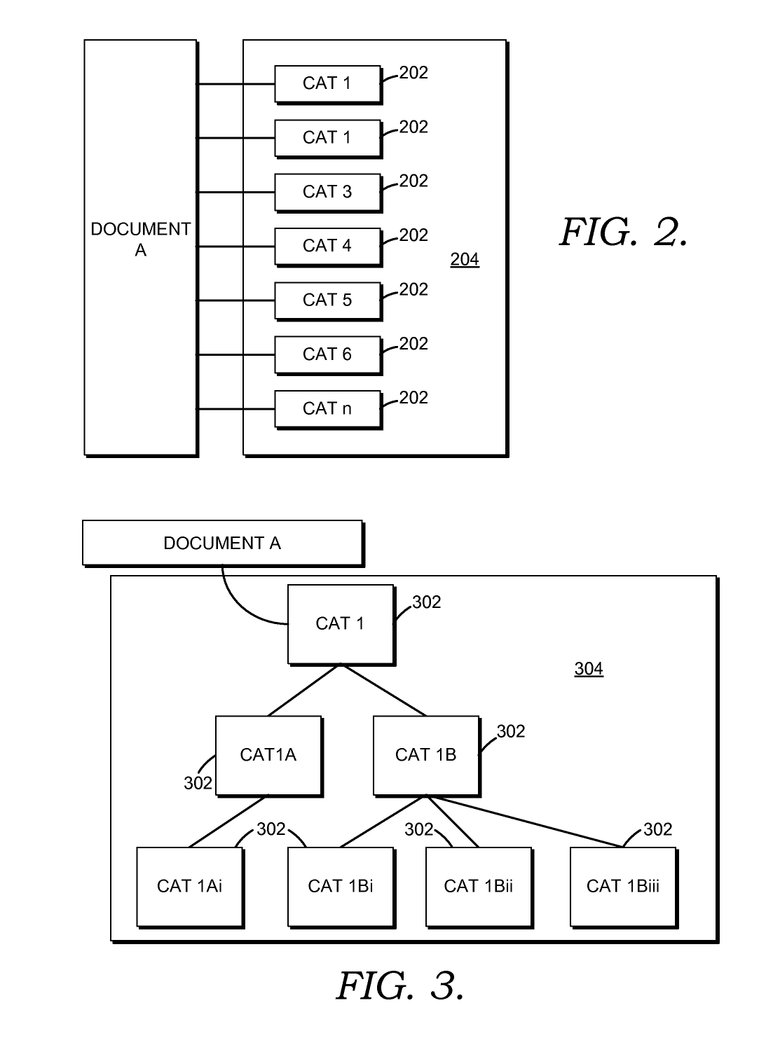

Additionally, in accordance with an embodiment of the invention, the documents are categorized into one or more document categories. Any desired data structure or arrangement of document categories and documents categorized therein is useable in embodiments of the invention. The description provided herein is not intended to limit, in any manner, the categorization and arrangement of document categories and documents therein. In an embodiment, a document A is associated with categories 202 from a flat category space 204, depicted in FIG. 2, or document A is associated with categories 302 from a hierarchically arranged category space 304, depicted by FIG. 3. A document A might also be associated with categories from both flat and hierarchical category spaces 204, 304. Any number of categories can be employed. For example, a greater number of document categories are provided to increase the level of granularity or specificity exhibited by the document categories. A document category includes any number of documents classified therein.

A document may be associated with or categorized into one or many document categories. The terms associating and categorizing are used interchangeably herein and are not intended limit the relationships formed between documents and categories in embodiments of the invention. Any methods known in the art are used to categorize the documents into their respective document categories. For example, documents might be categorized based on subject matter, file type, date of creation, edit date, manual labeling by editors, manual labeling (either implicitly or explicitly) by users of the documents, or manual labeling by document creators, among various other methods known in the art. The description herein is not intended in any manner to limit or restrict methods by which documents may be categorized and/or the document categories that are employed. Documents can be associated with categories in a many-to-many, one-to-many, and many-to-one relationships.

In accordance with embodiments of the invention, document categories are associated with one or more document identifiers. The associations are many-to-many, one-to-many, many-to-one, and one-to-one relationships as desired. Document identifiers include any identifier, address, or other indicator of a document or its location. Document identifiers are referred to herein as uniform resource locators (URL) to avoid confusing the readers understanding of embodiments of the invention, although any identifiers, addresses, or other indicators of documents or their locations are useable in embodiments of the invention. For example, and not limitation, an internet protocol (IP) address or other numeric identification might be used.

URLs as they are known in the art describe the address or location at which a document is found on a network, the Internet, or a computing device. In an embodiment of the invention, URLs also describe the address or location of documents which are in some way associated with a document or document category. For example, considering a business document (such as a structured piece of data that includes a name, an address, a phone number, or the like, for a business), a URL could refer to a website related either to that business (for example, the official website of the business) or the category of the business (e.g. www.hotels.com). However, a URL as used herein, is not intended to limit application to the Internet or other networks. And a URL is descriptive of any file locating system or naming convention such as, for example, and not limitation, a hypertext transfer protocol (HTTP) address, an Internet protocol (IP) address, or a file naming scheme.

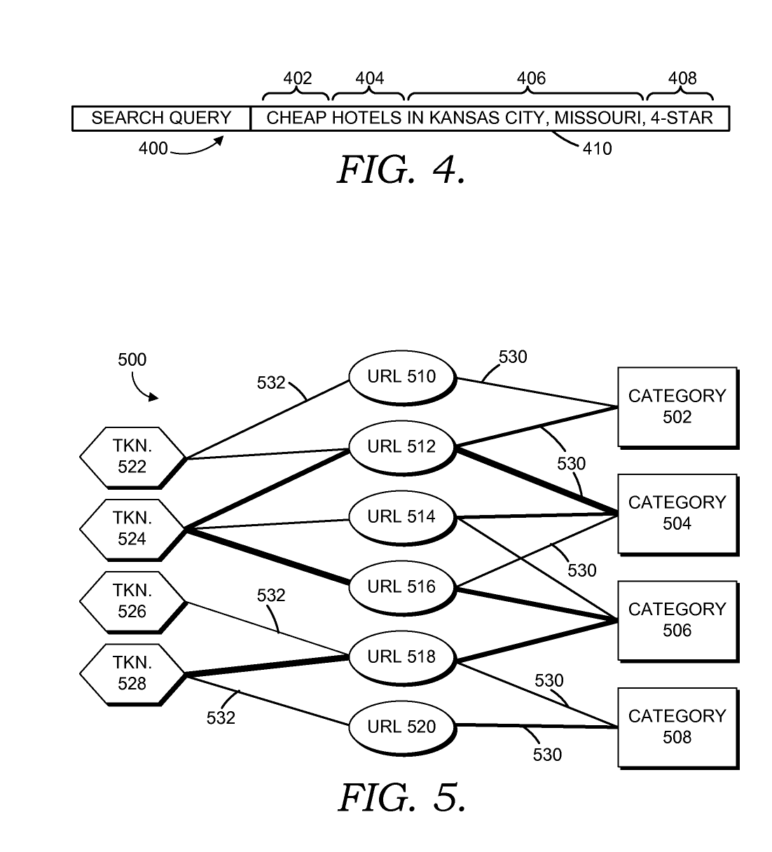

Embodiments of the invention provide enrichment of metadata associated with document categories and documents. The metadata is comprised of any data known in the art that is descriptive of, or that can be used to describe a document category or a document. In an embodiment the data includes text tokens, hereinafter tokens, that are made up of one or more textual words, numbers, or other symbols known in the art. The tokens are obtained from any available source known in the art such as, for example, and not limitation, user entered search queries, anchor text in a web page, web page text, file names, or terms that are provided by a human editor or are machine generated. In an embodiment, multiple sources of tokens are employed. For instance, tokens are received as search query terms entered by a user into a search query field, as depicted in FIG. 4, or tokens might be identified by an application that parses web page text to identify key words or phrases. Such a search query may include a plurality of search query terms and can be referred to as a token string that is comprised of a plurality of tokens. Any desired methods for identifying tokens that are descriptive of document categories or documents therein are useable in embodiments of the invention.

In an embodiment, tokens strings are normalized to remove any information which is known or believed to be irrelevant to the task of describing a document category. In an embodiment, a token string that includes more than one token such as, for example, “swimwear in London” is normalized by removing one or more of the tokens that are identified as irrelevant for defining a category for the token string. For example, the token string “swimwear in London,” obtained from a user-entered search query string includes location information, e.g. “in London.” As such, the tokens “in London” might be determined to be irrelevant to describing a document category, for example, in a business context where location is irrelevant to categorization based on a field of business. Thus, the token string is normalized by removing the tokens “in London” leaving only the token, “swimwear.”. Thereby, the token “swimwear” can be descriptive of a category for apparel business documents. Token strings might also be normalized to remove tokens that comprise for example pronouns, prepositions, misspellings, non-textual words, and the like.

With reference to FIG. 4, an exemplary token string 400 with the tokens “cheap” 402, “hotels” 404, “in Kansas City, Mo.” 406, and “4-star” 408 is received from a user as a search query in a search query field 410 of a search engine. In this case the token string might be normalized, for the purpose of categorization, to remove the tokens “in Kansas City, Mo.” 406, because the data is irrelevant to categorizing documents relating to hotels or travel. Each of the tokens “cheap” 402, “hotels” 404, and “4-star” 408 are each useable as individual tokens or can be combined into one or more combined tokens. It is to be understood that execution of the search query by a search engine is independent of the use of the search query as a token string for normalization and categorization.

With reference now to FIG. 5, in an embodiment of the invention, a graph 500 depicting relationships between categories 502-508, URLs 510-520, and tokens 522-528 is generated. It is to be understood that the block diagram depicted in FIG. 5 is a visual representation of the mathematical relationships that compose the graph 500; the graph 500 need not include a visual representation. In an embodiment, the graph 500 is generated mathematically and a visual representation thereof is not rendered or drawn. The categories 502-508 are linked to one or more URLs 510-520 by links 530. The URLs 510-520 are linked or associated with one or more tokens 522-528 by links 532. The links between tokens 522-528 and URLs 510-520 may be many-to-many, one-to-many, many-to-one, and one-to-one relationships. The links 530, 532 between the categories 502-508, URLs 510-520, and tokens 522-528 can include one or more of a confidence level or other statistical correlation between the nodes of the graph 500. The links 530, 532 are depicted in FIG. 5 by lines having varied thickness to indicate variation in a weight, confidence level, or strength of the association between a given category 502-508 and URL 510-520 or between a token 522-528 and a URL 510-520. It is to be understood that the depiction of the links 530, 532 is exemplary and is not intended to indicate any particular weighting or arrangement of links 530, 532 between tokens 522-528, URLs 510-520, and categories 502-508. The confidence level or statistical correlations depicted by the links 530, 532 are calculated by any desired method including explicit human judgment (e.g., an administrator supplying a manual relevance judgment), implicit human judgment (e.g., a user providing a search query that includes a token and then selecting a search result URL thereby indicating a relationship between the token and the URL), or by one or more algorithms. Further, multiple sources of evidence of the correlation depicted by the links 530, 532 can be used and combined to calculate the confidence level or statistical correlation.

With continued reference to FIG. 5, the URLs 510-520 provide a linking layer between the categories 502-508 and the tokens 522-528. Thus, the tokens 522-528 can be related to the categories 502-508 and the documents therein based on their association with the intermediate URLs 510-520. For example, a category 502-508 for business documents might have URLs 510-520 that are associated with business listings or business web pages. Those URLs 510-520 might be associated with or have therein one or more tokens 522-528 that can be used to describe documents that are related to the URLs 510-520. Thus, the tokens 522-528 that are associated with the URLs 510-520 can thereby be propagated to the category 502-508 and to documents in the category 502-508. In an embodiment, the tokens 522-528 are automatically propagated to the categories 502-508 and documents in the categories 502-508 without user interaction.

Accordingly, the wealth of tokens 522-528 that are descriptive of a document associated the category 502-508 is expanded based on all of the documents within the category 502-508 and the URLs 510-520 associated with the category 502-508. The weighting of the associations and links 530, 532 between the tokens 522-528, URLs 510-520, and categories 502-508 may also be used to indicate the confidence that a given token 522-528 is actually descriptive of a document within the category 502-508. In an embodiment, the confidence level data for a token's association with a document or document category is provided to a search engine and is utilized when identifying a document based on one or more search query terms that correlate with the token 522-528.

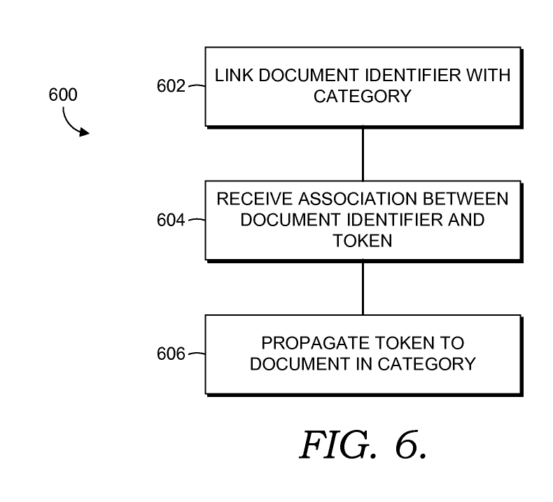

With reference now to FIG. 6, a method 600 of enriching metadata associated with a category of documents is described in accordance with an embodiment of the invention. Initially, one or more documents are pre-categorized in a category as described above, by any desired method. A document identifier is linked with one or more of the categories, as indicated at 602. The document identifier is linked to a category based on, for example, the documents contained in the category or an implicit or explicit linking of the document identifier to the category. For example, a URL that leads to a specific document that is categorized within a given category is linked to that category. In another example, an administrator may explicitly link a document identifier with a category based on a one or more known characteristics of the document identifier or of the category. Additionally, the document identifier can be linked to a category based on implicit knowledge of the document identifier and/or the category. For example a document identifier known to be associated with a business document or a category associated with the business document is linked with a business documents category even if no documents located by the document identifier are presently contained within the category.

At 604, evidence of an association between a token and the document identifier is received. The evidence indicates a relation or correlation between the token and the document identifier such that the token might describe documents associated with the category or categories of the document identifier. The evidence may be acquired or received by any desired method. For example, a user might enter a search query that contains one or more tokens. Upon execution of the search query the user is presented with one or more search result URLs based on the search query. A user selection of one of such URLs indicates a relationship between the search query terms or tokens and the URL.

Additionally, in another embodiment, a token is identified based on a web page located by the document identifier. For example, the token comprises anchor text or other text found on a web page either located at or linking to the address indicated by the document identifier. Anchor text, as described herein, includes one or more words in a document that provide a hypertext link to another web page or document. Further, the evidence of an association between a token and the document identifier might result from an analysis of text on a web page located by the document identifier. For example, web page text may be parsed to identify one or more terms or keywords that relate to the subject of the text as is known in the art.

Upon linking of document identifier with categories and associating tokens to the document identifier, the tokens are propagated to the categories or the documents therein, as indicated at a step 606. As such, the documents in the category and/or the category itself are provided with one or more tokens that are descriptive of the category.

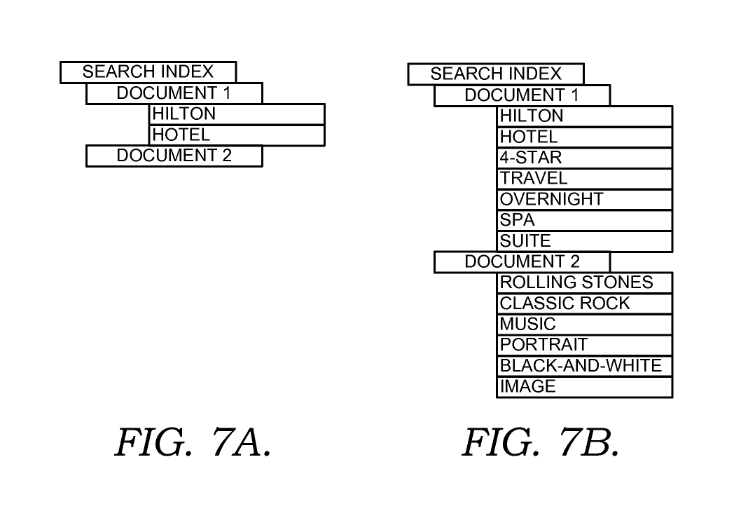

Thus, categories and documents within the categories can be indexed with the tokens as metadata describing each of the categories or the documents therein. By indexing the categories and/or documents therein with the associated tokens, the number of search terms that might be entered that would result in retrieval of a document is increased. Documents and categories are thus retrievable with greater recall or coverage and with decreased demand for a well-crafted search query. For instance, with reference to FIGS. 7A and 7B, a document indexed without tokens propagated as described by the method 200 might appear as depicted in FIG. 7A. Document 1 depicted in FIG. 7A only has two metadata tokens associated therewith; document 2, which comprises, for example, an image file has no metadata associated therewith. Therefore, a search engine will have difficulty identifying the documents 1 and 2 as potential search results unless a search query includes the terms “Hilton” or “hotel.”

In contrast, by propagating tokens as described by the method 600 and depicted in FIG. 7B to documents 1 and 2, the amount of metadata associated with, and indexed with documents 1 and 2 is greatly increased. A user searching for either of documents 1 or 2 can more easily and more precisely discover the desired documents.

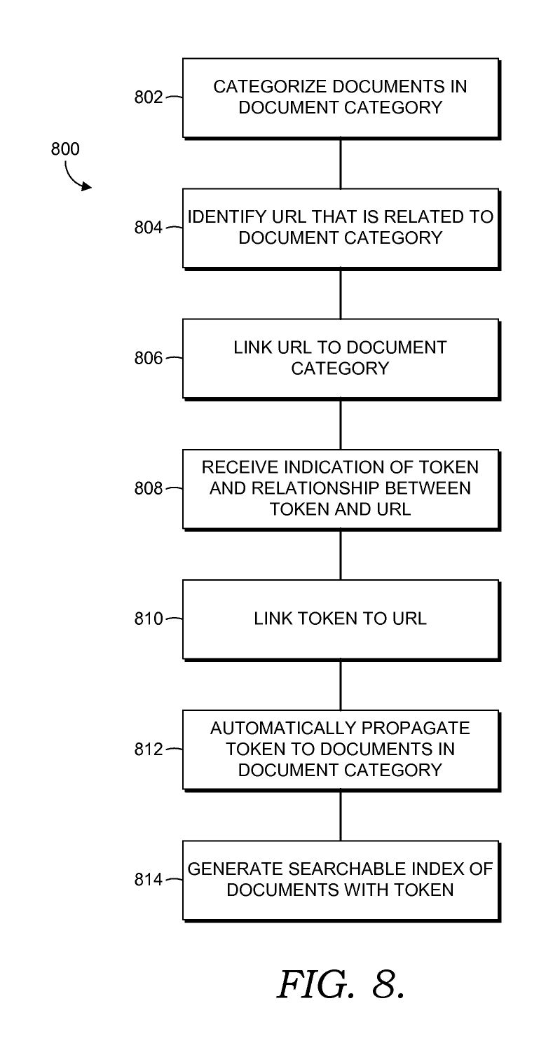

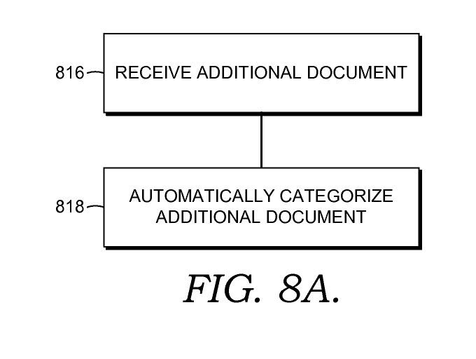

With reference now to FIG. 8, a method 800 for enriching metadata associated with a document that is categorized in a document category is described in accordance with an embodiment of the invention. At 802, documents are associated with or categorized in a document category. As described previously above, documents may be categorized in any desired manner based on for example, their subject matter, their content, their format, and the like. A document identifier comprising a URL that is related to the document category is identified, as indicated at a step 804. The URL may be related to the document in any desired manner, e.g., the document may be located at the URL, related by subject matter or content, or the document may be explicitly related by an administrator/editor, among others. The URL is linked to the document category, as indicated at a step 806. The linking may be provided with a weighting factor or a confidence level to indicate the strength of the association between the URL and the document category.

An indication of a token and a relationship between the token and the URL is received, as indicated at a step 808. The indication may be received based on user interaction or statistical analysis of data related to the URL and the token. At a step 810, the token is linked to the URL. In an embodiment, the link between the token and the URL is also provided with a confidence factor or a weight.

Based on the linking between the URL and the document category and between the token and the URL, the token is propagated to the documents categorized in the document category, as indicated at a step 812. The token can be propagated based on one or more algorithms and can be propagated automatically without user interaction. In an embodiment, the document categories are arranged in a flat category space and are each associated with the token individually, as depicted in FIG. 2. In another embodiment, the document categories are hierarchically arranged as depicted in FIG. 3. In a hierarchal document category arrangement additional algorithms may be applied to identify the specific categories or levels of the hierarchy with which a given token should be associated.

A searchable index of the documents in the document category and the tokens that are associated therewith is generated, as indicated at a step 814. A searchable index may include additional tokens, metadata, and synonyms associated with a category or documents within the category that are from additional, disparate sources. Thus, the method 800 enriches or enhances an existing searchable index or may generate a new searchable index.

With additional reference to FIG. 8A, an additional document that has not been categorized into one or more of the document categories is received, as indicated at a step 816. The additional document includes one or more external tokens that have been associated therewith by methods like the method 800 or others known in the art. One or more of the external tokens may match or nearly match the tokens of the categorized documents. When the external tokens match or nearly match, the document are automatically categorized or mapped into an appropriate category for the document based on the linking between the tokens and URLs and between the URL and categories provided by the method 800, as indicated at a step 818. Thus, a graph generated by linking the tokens, URLs, and categories is continually expanded and enriched with the addition of new documents having additional external tokens associated therewith.

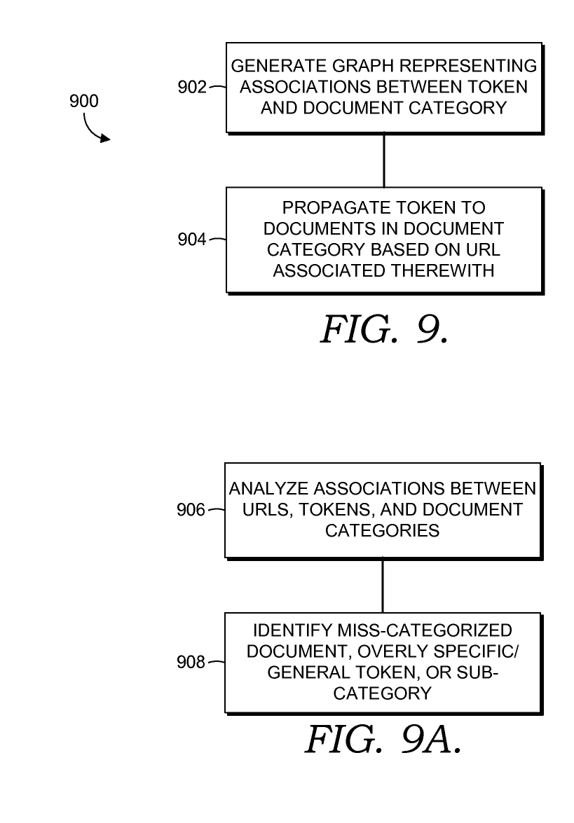

With reference now to FIG. 9, a method 900 for enriching metadata associated with a document that is categorized in at least one of a plurality of document categories in accordance with an embodiment of the invention is described. At a step 902, a graph, such as the graph 500, is generated that represents statistical associations between a text token and a document category. The graph includes document categories, document identifiers, and text tokens. As described previously above, the document categories each contain one or more pre-categorized documents; the document identifiers are each associated with one or more of the document categories; and the text tokens are associated with one or more of the document identifiers. The document identifiers, in this instance URLs, provide a linking layer between the tokens and the documents in the document categories. At a step 904, a token is propagated to documents in one or more categories based on an intermediate URL that is linked to both the token and to the document category. The token is thus usable as metadata that is descriptive of the category and/or each of the documents associated with the category.

With additional reference to FIG. 9A, associations between the URLs, the document categories, and the tokens are analyzed, at a step 906. The analysis identifies one or more of miscategorized documents, text tokens that are too specific or too general, or subcategories of documents within a document category, as indicated at a step 908.

A miscategorized document may be identified based on a number of characteristics visible in the graph. For example, a document comprising a recipe for pizza that is categorized in the category “banking” and that is associated with the token “interest rate” might be identified as being miscategorized based on one or more URLs or other tokens with which the document is associated. The miscategorization might be identified because the document is linked to URLs to which no other documents in the category are linked or based on a calculation of the confidence level of links between the document and URLs linked to the category.

Additionally, by identifying a document within a category that is associated with tokens that are different from the tokens associated with most other documents within the category, the document can be identified as being miscategorized. Using the above example, the document comprising the recipe for pizza that is categorized in the category “banking” might be associated with the tokens “Italian food,” “cooking,” and “recipes.” As no other documents in the “banking” category are likely to be associated with such tokens, the pizza recipe document is identifiable as miscategorized.

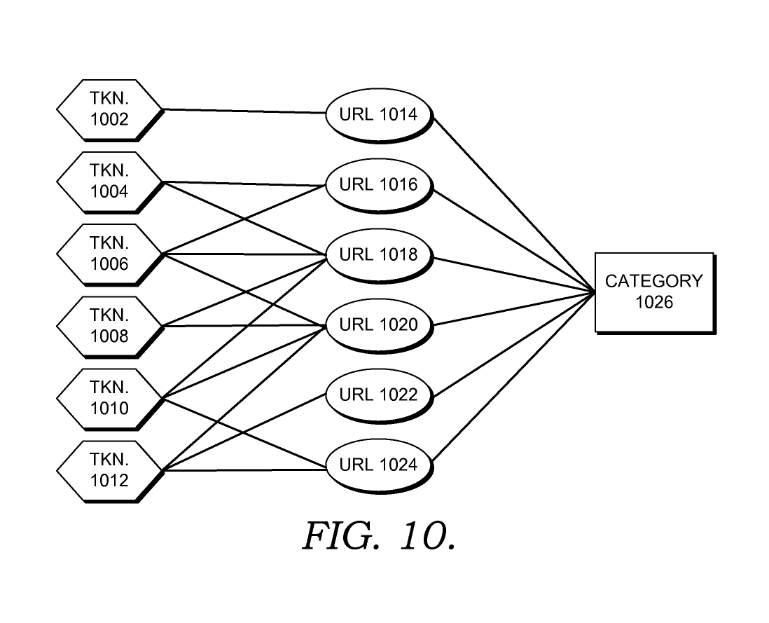

A text token that is too specific to be useful as a descriptor of a document category might be identified as depicted in FIG. 10. In FIG. 10, a token 1002 is only linked to a URL 1014 and the URL 1014 is linked to a category 1026. Further, tokens 1004-1012 are variously linked to URLs 1016-1024 which are also each linked to the category 1026. However, none of tokens 1004-1012 or URLs 1016-1024 are linked to the token 1002 or the URL 1014. It might be surmised that token 1002 is too specific in that it is only descriptive of documents associated with the URL 1014 and is thus not broad enough to be a useful descriptor of the category 1026 or documents within the category 1026. For example, where the category 1026 comprises the category “hotels” and the token 1002 is a textual word for a specific hotel, type of hotel, or chain of hotels such as, for example, “Weston Inn,” then the token 1002 may only be descriptive of the specific hotel named Weston Inn. As such, the token “Weston Inn” would not be a useful descriptor of hotels generally.

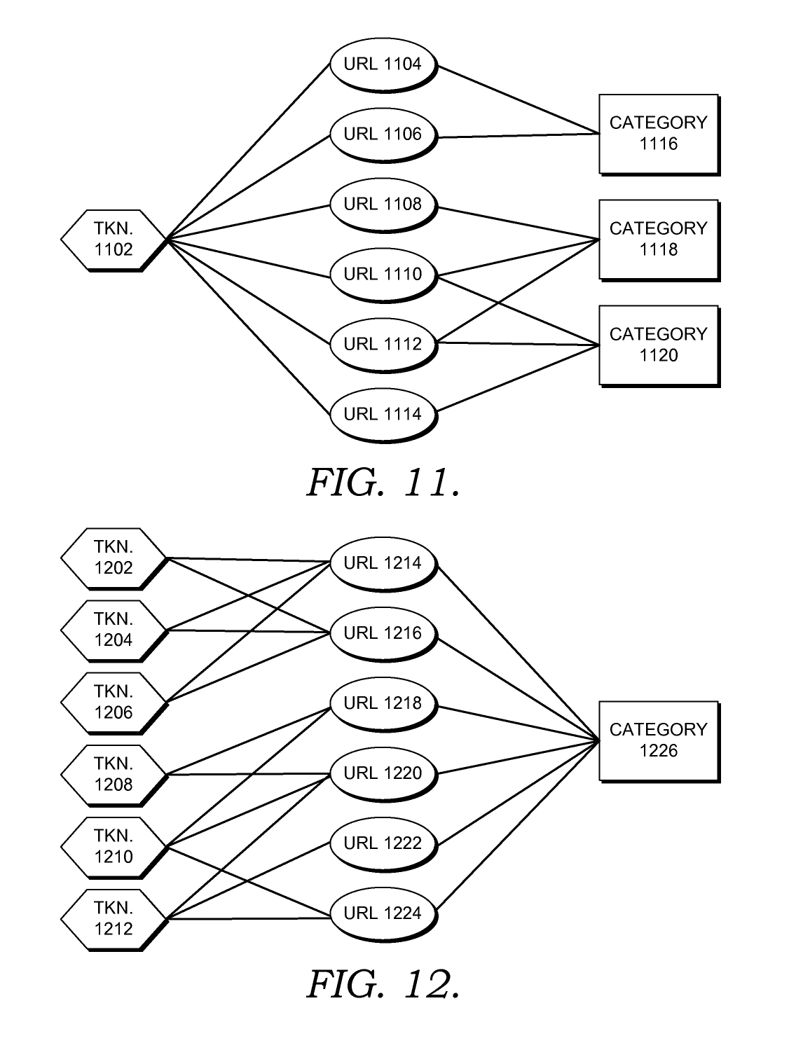

Conversely, as depicted in FIG. 11, a token 1102 that is too general is identified in accordance with an embodiment of the invention. In FIG. 11, the token 1102 is linked to URLs 1104-1112. The URLs 1104-1106 only link to a category 1114 while the URLs 1107-1112 variously link to a category 1118 and a category 1120. Thus, the token 1102 is too general in that it links to URLs across too many categories to be useful to identify a specific category or subset of categories. An example of such a token might be “www.” The token “www” is found in a vast majority of URLs used in Internet browsing and is therefore, too broad or too general to identify a specific category or document.

With reference now to FIG. 12, in another embodiment of the invention a grouping of tokens and URLs are identified to exhibit the existence of a subcategory within a document category. As depicted in FIG. 12, tokens 1002-1006 link to URLs 1014 and 1016 which each link to a document category 1026. Additionally tokens 1008-1012 link to URLs 1018-1024 which also link to the document category 1026. Thus, it might be concluded that two subcategories exist within the category 1026. For example documents that are most nearly linked to the URLs 1014 and 1016 and thus, to the tokens 1002-1006 comprise a first subcategory, while documents most nearly linked to the URLs 1018-1024 and thus, to the tokens 1008-1012 comprise a second subcategory. The identification of subcategories might be used to divide the documents within the category 1026 to form two new categories or a hierarchal sub-arrangement of documents within the category 1026 can be formulated.

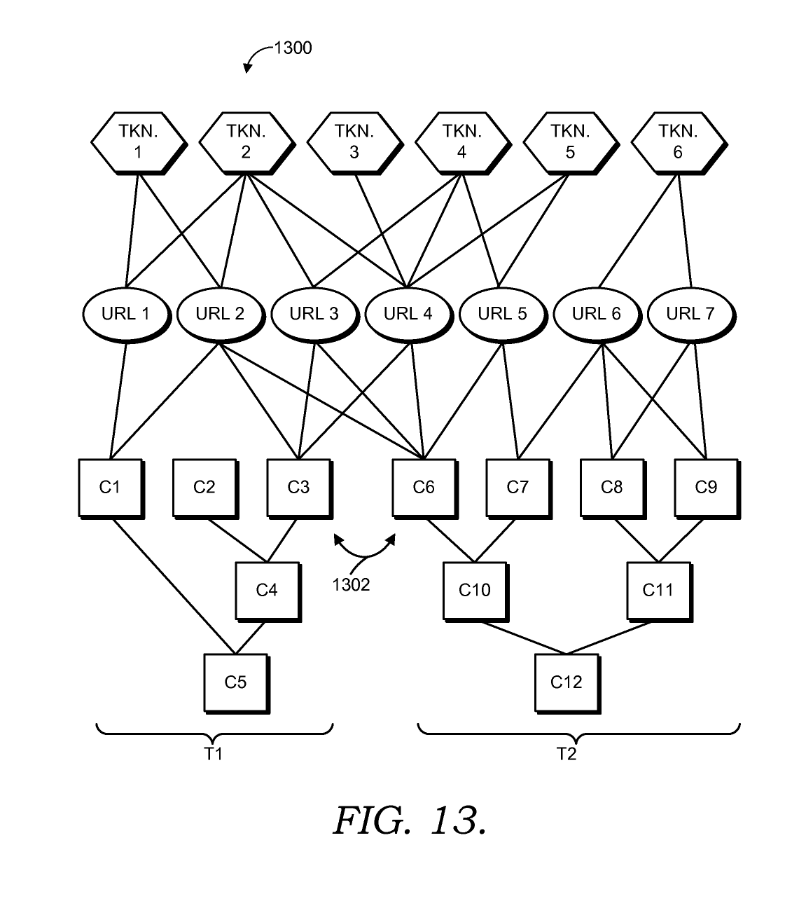

With reference now to FIG. 13, in another embodiment of the invention, a graph 1300 is usable to map together two or more sets of categories or documents each of which including respective different taxonomies T1 and T2. Taxonomy T1 including categories C1-C5 and taxonomy T2 including categories C6-C16. The categories C1-C12 are each associated with many similar or identical tokens and URLs. The graph 1300 is thus useable to identify relationships or similarities between the taxonomies based on the similar or identical URL and token associations. For example, as indicated at 1302, category C3 of taxonomy T1 and category C6 of taxonomy T2 are both associated with URLs 2, 3, and 4. Therefore, categories C3 and C6 can be combined when mapping the taxonomies T1 and T2 together. Additionally, the tokens 1-6 associated with the categories C1-C12 via the URLs 1-7 are useable to identify similarities and relationships between the taxonomies T1 and T2.

For example, the taxonomy T1 might provide a category “food” (C5) followed by a subcategory for “Italian” (C4) and a further subcategory for “pizza” (C3). The taxonomy T2 might provide a category “restaurants” (C12) followed by a subcategory “fast food” (C10) and a further subcategory “pizza” (C6). Parts of the two taxonomies T1 and T2 can be mapped onto one another based on the correlation of URL and/or token associations between the two “pizza” subcategories C3 and C6.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-readable media having computer-executable instructions embodied thereon that, when executed, perform a method of enriching metadata associated with a category of documents, the method comprising:
linking a document identifier with a category of documents;
receiving evidence of an association between a token and the document identifier, wherein the token comprises one or more data elements that are descriptive of content associated with the document identifier; and
propagating the token to the category of documents that is linked with the document identifier, wherein the token is useable as metadata for one or more of the category of documents and a document in the category of documents.

2. The media of claim 1, wherein the token comprises a textual data element.

3. The media of claim 2, wherein the token is obtained from a search query that includes a plurality of search terms, the plurality of search terms forming a token string, wherein the token string is normalized to identify the token by removing one or more search terms from the token string that are irrelevant as descriptors of the category of documents.

4. The media of claim 1, wherein the document includes one or more of a text document, a web page, an image, a video, a file, or a combination thereof.

5. The media of claim 1, wherein a link between the URL and the category of documents and the association between the token and the URL are weighted based on a confidence therein.

6. The media of claim 1, wherein the document is indexed with the token in a search index.

7. The media of claim 1, wherein one or more of a link between the URL and the category of documents and an association between the token and the URL is employed to identify a miscategorized document.

8. The media of claim 1, wherein one or more of a link between the URL and the category of documents and an association between the token and the URL is employed to determine that the token is too specific or too general to be useful as metadata for the category of documents or the document in the category of documents.

9. The media of claim 1, wherein one or more of a link between the URL and the category of documents and an association between the token and the URL is employed to identify one or more sub-categories of documents within the category of documents.

10. The media of claim 1, wherein one or more of a link between the URL and the category of documents and an association between the token and the URL aids in mapping two or more taxonomies on to one another.

11. A method performed by a computing device having a processor and memory for enriching metadata associated with a document that is categorized in a document category, the method comprising:
categorizing a document in a document category;
identifying a document identifier that is related to the document category;
linking the document identifier to the document category;
receiving an indication of a token and a relationship between the token and the document identifier;
linking the token to the document identifier;
propagating via a computing device having a processor and a memory, the token to the document that is categorized in the document category;
generating a searchable index of a plurality of documents that includes the document and the token as metadata for the document.

12. The method of claim 11, wherein the token comprises one or more textual words.

13. The method of claim 12, wherein the indication of a relationship between the document identifier and the token is received by identifying a document identifier selected by a user from a group of document identifiers presented as search results in response to the user entering a search query, and wherein the search query includes the token as a search term.

14. The method of claim 13, wherein the search query includes a plurality of search terms that form a token string and the token string is normalized to remove tokens that are irrelevant to describing documents in the document categories.

15. The method of claim 14, wherein normalizing the token string includes removing tokens that are one or more of pronouns, prepositions, misspellings, non-text, or that describe a location.

16. The method of claim 11, wherein the token is automatically identified and linked to the document identifier without intervention from a human administrator.

17. The method of claim 11, further comprising:
receiving an additional document that is not part of the plurality of documents and that has the token associated therewith; and
automatically categorizing the additional document in the document category.

18. The method of claim 11, wherein one or both of a link between the document identifier and the document category and a link between the document identifier and the token are weighted based on a confidence calculation.

19. One or more computer-readable media having computer-executable instructions embodied thereon that, when executed, perform a method of enriching metadata associated with a document that is categorized in at least one of a plurality of document categories, the method comprising:
generating a graph that represents statistical associations between a text token and a document category, wherein the graph includes:
(1) a plurality of document categories, wherein one or more documents are associated with each of the document categories,
(2) a plurality of uniform resource locators (URL), each of which is associated with one or more of the document categories, and
(3) a plurality of text tokens that are associated with one or more of the URLs;
propagating a first text token of the plurality of tokens to documents associated with a first document category of the plurality of document categories based on a first URL of the plurality of URLs that is associated with the first text token and with the first document category, wherein the first text token is useable as metadata that is descriptive of each of the documents associated with the first document category.

20. The media of claim 19, further comprising:
analyzing associations between the plurality of URLs, the plurality of document categories, and the plurality of text tokens; and
identifying one or more of a miss-categorized document, a text token that is too specific, a text token that is too general, or a sub-category of documents within a document category.
